(19) United States
(12) Patent Application Publication
(10) Pub. No.: US 2024/0281769 A1
(43) Pub. Date: Aug. 22, 2024

(54) CODED SERVICE AID SYSTEM FOR SERVICABLE UNITS

(71) Applicant: Toshiba Global Commerce Solutions, Inc., Durham, NC (US)

(72) Inventors: Brad M. Johnson, Raleigh, NC (US); Daniel Paul Kelaher, Fuquay-Varina, NC (US)

(21) Appl. No.: 18/112,782

(22) Filed: Feb. 22, 2023

(51) Int. Cl. G06Q 10/20

(52) U.S. Cl. CPC G06Q 10/20; G09G 3/32; G09G 2330/026

(57) ABSTRACT

Systems and methods for service technicians to use when called upon to diagnose and repair electronic or electro-mechanical systems are provided. In one exemplary embodiment, a method is performed by an electronic display coupled to a location on a serviceable unit that is visible at an external region of the serviceable unit. The electronic display is operable to enable presentation of a digital image. The method includes powering the electronic display to enable display of the digital image when the serviceable unit receives an error. The digital image is indicative of a Universal Resource Locator (URL) associated with the error.

### BACKGROUND

Service calls for the purpose of troubleshooting and/or repairing complex electronics or electro-mechanical systems are ideally implemented as quickly and efficiently as possible. In many cases, a service technician is called to a facility having tens or even hundreds of serviceable units distributed about the facility. Accordingly, the time for a service call can include time needed just to locate the unit requiring service and/or finding the personnel to direct the technician to the unit. Once located, the technician must undertake a troubleshooting process that may include opening up the unit to access the unit's built-in troubleshooting aids. However, if a unit has experienced an electrical failure such that the unit is no longer powered, the unit's troubleshooting aids may also be compromised thereby making the technician's troubleshooting and/or repair much more difficult and time consuming.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1 illustrates one embodiment of a serviceable system configured with a coded service aid system in accordance with various aspects as described herein.

FIG. 2 illustrates another embodiment of a serviceable system configured with a coded service aid system in accordance with various aspects as described herein.

FIG. 3A illustrates one embodiment of a coded service aid system in FIG. 1 in accordance with various aspects as described herein.

FIG. 3B illustrates another embodiment of a coded service aid system in FIG. 1 in accordance with various aspects as described herein.

FIG. 3C illustrates one embodiment of a coded service aid system in FIG. 2 in accordance with various aspects as described herein.

FIG. 4A illustrates one embodiment of a method by an electronic display coupled to a serviceable unit in accordance with various aspects as described herein.

FIGS. 4B-4C illustrate another embodiment of a method by an electronic display coupled to a serviceable unit in accordance with various aspects as described herein.

### DETAILED DESCRIPTION

For simplicity and illustrative purposes, the present disclosure is described by referring mainly to exemplary embodiments thereof. In the following description, numerous specific details are set forth in order to provide a thorough understanding of the present disclosure. However, it will be readily apparent to one of ordinary skill in the art that the present disclosure may be practiced without limitation to these specific details.

Service technicians are called upon to diagnose and repair complex electronic or electro-mechanical systems quickly, efficiently, and effectively. Very often, facilities housing a failed system requiring repair are large and house many such systems (e.g., point-of-sale terminals, self-checkout systems, appliances, a variety of “internet of things” systems or units, etc.). When a service technician arrives at such a facility, his or her first task is to locate the failed system and then undertake troubleshooting tasks. While these tasks would appear to be simple and straightforward, there are several obstacles that can extend the time required to accomplish them. For example, the size of a facility and the number of electronic or electro-mechanical systems housed in the facility can number into the hundreds thereby making the task of locating the failed system tedious and time consuming. In addition, even when the failed system is located, the technician frequently has to spend the time to open up one or more parts of the failed system in order to access various troubleshooting aids within the system. In cases where the failed system has completely shut down, the failed system's provided troubleshooting aids may be disabled thereby further increasing the time to repair the failed system. Accordingly, there is a need for improved methods and systems for a service technician to quickly locate a failed serviceable system and then readily commence the troubleshooting and repair of the failed serviceable system.

In this disclosure, methods and systems are provided for service technicians to use when locating, troubleshooting, and repairing a failed serviceable system or unit. In one exemplary embodiment, a coded service aid system is a device that includes an electronic display coupled to a location on a serviceable unit that is visible at an external region of the serviceable unit. The electronic display (e.g., a matrix of LEDs) is operable to enable presentation of a digital image (e.g., a QR code) only when the serviceable unit receives (e.g., from a sensor) an error. The digital image is indicative of a Universal Resource Locator (URL) associated with the error (e.g., a website link providing information about the particular error and its repair). A power source (e.g., super or ultra capacitor) coupled to the electronic display is operable to provide power to the electronic display to display the digital image when the serviceable unit receives the error. One of the benefits of the device is that the technician can use the visibility of the device as a means to readily identify that the particular serviceable unit has a failure since the digital image display is visible at an external region thereof and since it is operable when an error is received. An additional benefit is that since the image being displayed (e.g., QR code) is indicative of a URL associated with the error, the technician can simply use their smartphone to access the error information without having to take the time to open up the serviceable unit. In another embodiment, a light device is coupled to the serviceable unit and is configured to enable its visibility (e.g., at an easily seen height) even when the serviceable unit is not visible. The light device is coupled to the power source and is operable to enable a visible indication of the light device when the serviceable unit receives the error (e.g., at the same time the electronic display is enabled) thereby providing the technician with the ability to locate the failed serviceable unit even when they cannot actually see it.

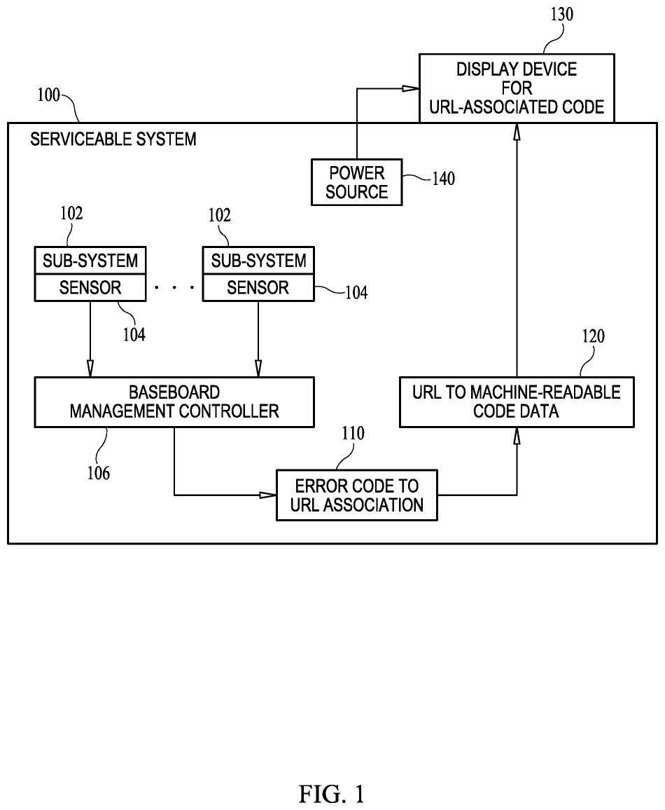

In one example of the present disclosure, FIG. 1 illustrates an existing serviceable system 100 such as one of those mentioned above. Relevant to the present disclosure, serviceable system 100 may include multiple sub-systems 102 (e.g., motors, optical readers, fans, power supplies, belt drives, etc.). Each of sub-systems 102 may have one or more sensors 104 coupled thereto and configured to sense or detect when a problem (e.g., circuit overload, motor failure, fan speed issue, high temperature, high humidity, excess tension, operation outside of prescribed limits, etc.) associated with that sub-system occurs. The outputs of sensors 104 are sent to the serviceable system's baseboard management controller (BMC) 106 that is provided onboard serviceable system 100 to monitor the physical state thereof via sensors 104. For example, BMC 106 can be operably coupled to or incorporated with the serviceable system's motherboard or main circuit board (not shown). The particular configuration of serviceable system 100 to include types/numbers sub-systems 102, sensors 104, and BMC 106 is not a limitation of the present disclosure.

In an example illustrated in FIG. 1, when the BMC 106 receives a signal from one of the sensors 104 indicating that an error has been sensed, the BMC 106 generates an error code. The error code associated with the error is operably coupled to a processing block or module 110 that associates the error code with a Universal Resource Locator (URL). The associated URL may point to, for example, a Hyper Text Markup Language (HTML) page, a Cascading Style Sheets (CSS) document, an image, a video, etc., that is associated with the particular error. For example, the URL could be a link to text data that explains the error, explains how to further diagnose the error, explains how to repair the error, identifies the parts needed for a repair, etc. In other examples, the URL could be a link to a website containing a set of additional website links (e.g., a parts link, a repair video link, etc.) addressing the error. In other examples, the URL associated with the error could be a link to a stepwise tutorial concerning treatment of the error.

Following the association of the particular error to its corresponding URL, a processing block or module 120 operably coupled to the processing block 110 generates machine-readable code data corresponding to the URL associated with the error. For example, the machine-readable code may be one readable by a smartphone or tablet such as a QR code, bar code, dot code, etc. In another example, the machine-readable code may be a proprietary two-dimensional code design that a manufacturer of the serviceable system 100 uses to ensure that only its authorized technicians can read/access by means of, for example, operation of a proprietary app downloaded and operable on the technician's smartphone or tablet.

The processing block 120 may be operably coupled to a display device 130 operable to enable presentation of a digital image. In the example illustrated in FIG. 1, the display device 130 may be configured to present a machine-readable image, a two-dimensional image, a three-dimensional image, a mixed reality image, a virtual image, or an augmented reality image. The data generated at the processing block 120 is provided to the display device 130 that is positioned at a location on the serviceable system 100 that is readily visible at an external region of the serviceable system 100. For example, the display device 130 may be located on the front face or top face of the serviceable system 100 so that it is readily visible when one is in front of the serviceable system 100. In another example, the display device 130 may be located adjacent to a tag or label (not shown) indicating a manufacturer of the serviceable system 100, a model name/number of the serviceable system 100, serial number of the serviceable system 100, etc.

In the example illustrated in FIG. 1, the display device 130 is operable to present the machine-readable code data generated by the processing block 120 when such data is generated. In some embodiments, the display device 130 is only enabled to be operable when an error signal has been received by the serviceable system 100 from one or more of its onboard sensors 104. In this way, the presentation of a machine-readable code on the display device 130 serves as an indication that an error has occurred in the serviceable system 100.

In some embodiments, the display device 130 may be a two-dimensional matrix of light-emitting diodes (LEDs) that may be illuminated to reproduce, for example, a QR code or dot code. The LEDs may be one or more colors where the colors may be used to enhance the visibility of the displayed code. The display deice 130 may be powered by a power source 140 that, in the case of an LED matrix, may be a low-power source derived from or maintained on the serviceable system 100. In other embodiments, the display device 130 may be a non-volatile display device such as an e-ink display in which case the machine-readable code data may be flashed thereto.

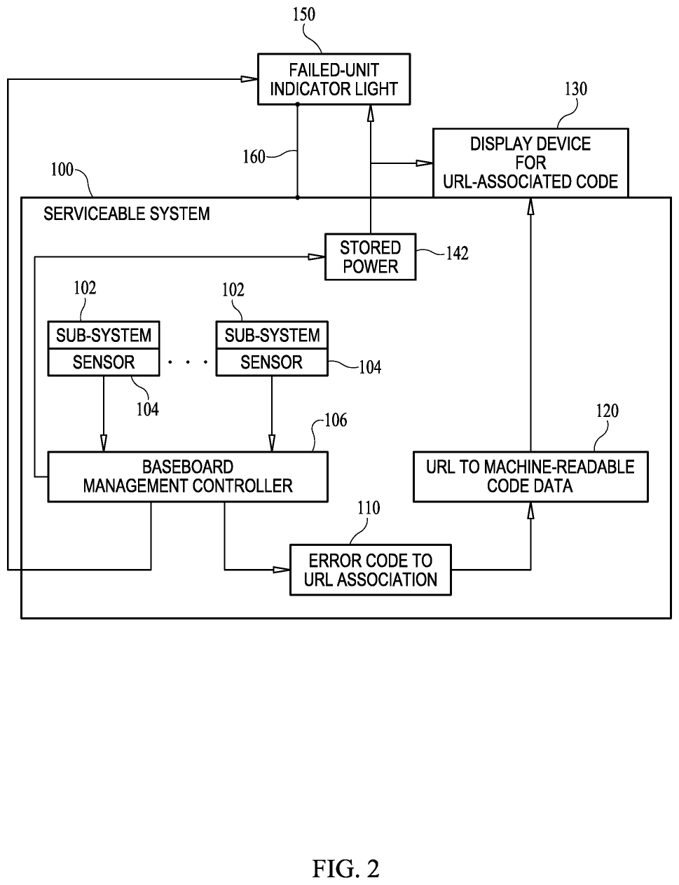

In another embodiment illustrated in FIG. 2, an additional visible indication of a received error in the serviceable system 100 may be provided. In the example illustrated in FIG. 2, a failed-unit indicator light 150 (e.g., solid or flashing lights/LEDs) may be coupled to the serviceable system 100 by a mount 160 such that the indicator light 150 may be seen even when the serviceable system 100 is not visible. For example, the mount 160 may be a stand or pole affixed to the serviceable system 100 and configured to position the indicator light 150 at a height above the serviceable system 100 such that it may be readily seen even when the serviceable system 100 cannot. In this way, when lit, the indicator light 150 provides a technician with a macro location of the serviceable system 100 thereby allowing the technician to quickly identify and locate a failed serviceable system even when in a large facility containing tens/hundreds of serviceable systems.

In some embodiments, the display device 130 and indicator light 150 are enabled for operation only when an error has been received by the BMC 106 of the serviceable system 100. In some embodiments, power for the display device 130 and the indicator light 150 is simultaneously supplied by a stored power device 142 maintained on the serviceable system 100 and controlled by, for example, the BMC 106. For example, the stored power device 142 may be a super or ultra capacitor circuit operable to store energy during normal operating times (e.g., prior to the sensing of an error) of the serviceable system 100. The stored power device 142 may be controlled by the BMC 106 to enable operation of both the display device 130 and the indicator light 150 when an error is received. The stored power device 142 may be operable to power both the display device 130 and the indicator light 150 even if the serviceable system 100 is without power.

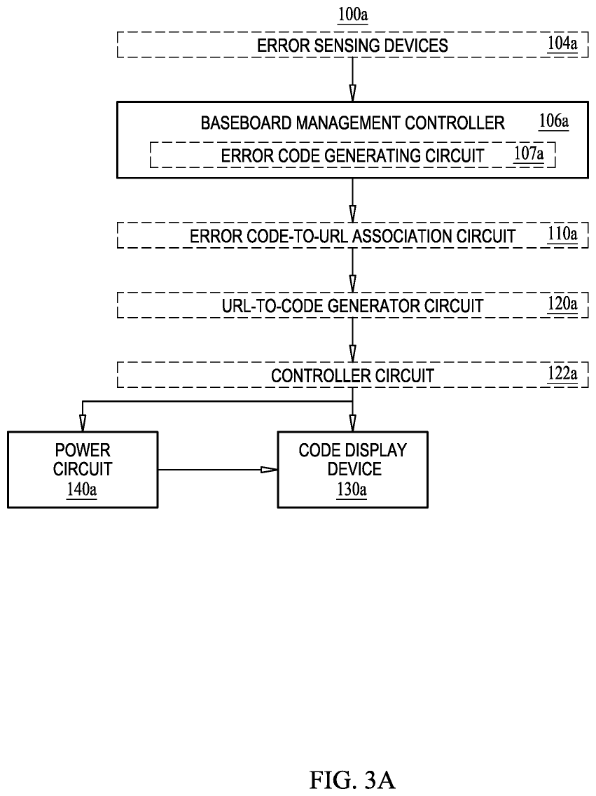

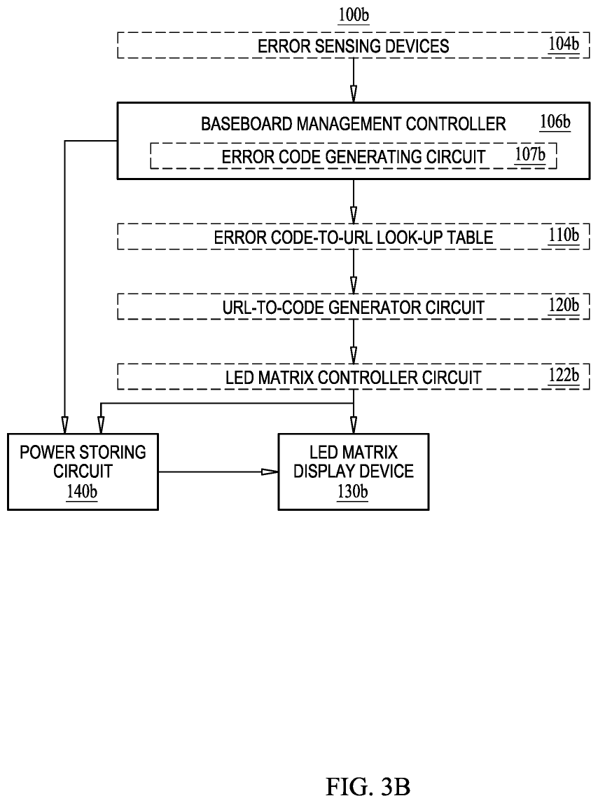

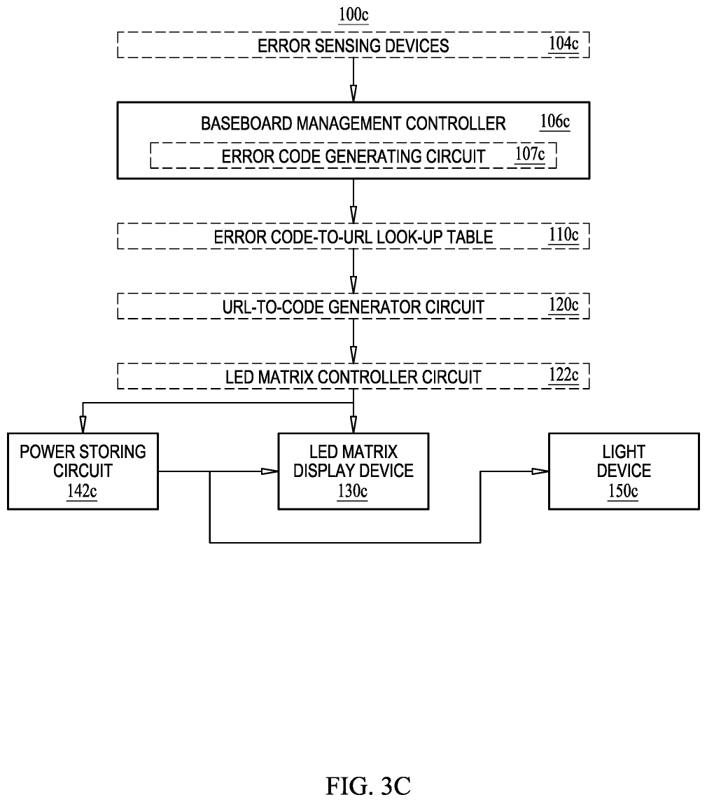

FIG. 3A illustrates one embodiment of a serviceable system 100a configured with a coded service aid system in accordance with various aspects as described herein. In FIG. 3A, the serviceable system 100a implements various functional means, units, modules, or circuits (e.g., via the processing and control provided by BMC 106 and the processing blocks 110/120 in FIG. 1 and their software code or the like). In one embodiment, a baseboard management controller (BMC) 106a may be operable to receive error messages from a set of error sensing devices 104a (e.g., sensors 104 operable to sense or detect an error occurring in the respective sub-system 102 as in FIG. 1). In one embodiment, the BMC 106a includes, for instance, an error code generating circuit 107a that generates an error code each time the BMC 106a receives an indication of an error as sensed by one of the error sensing devices 104a. The generated error code may be associated, at an association circuit 110a, with a URL that provides a connecting link to a source of information about the particular error as described above. The URL may be provided to a circuit 120a operable to generate data indicative of a machine-readable code identifying the URL associated with the particular error. The machine-readable code data may be provided to a controller circuit 122a operable to send the machine-readable code data to a code display deice 130a. In one embodiment, a power circuit 140a (e.g., a battery circuit, a capacitance-based power storing circuit configured to receive and store power from the serviceable system 100a during time normal operation thereof, etc.) may be coupled to the controller circuit 122a and the code display device 130a such that the controller circuit 122a only enables the code display device 130a to be operable via the power circuit 140a when there is URL-indicating machine-readable code data ready to be displayed for indication of the particular error received by the serviceable system 100a. In this way, the code display device 130a is operable for illumination only when an error has been received by the serviceable system 100a.

FIG. 3B illustrates another embodiment of a serviceable system 100b configured with a coded service aid system in accordance with various aspects as described herein. In FIG. 3B, the serviceable system 100b implements various functional means, units, modules, or circuits (e.g., via the processing and control provided by BMC 106 and the processing blocks 110/120 in FIG. 1 and their software code or the like). In one embodiment, a baseboard management controller (BMC) 106b may be operable to receive error messages from a set of error sensing devices 104b (e.g., sensors 104 operable to sense or detect an error occurring in the respective sub-system 102 as in FIG. 1). In one embodiment, the BMC 106b includes, for instance, an error code generating circuit 107b that generates an error code each time the BMC 106b receives an indication of an error as sensed by one of the error sensing devices 104b. A look-up table 110b may be used to associate the generated error code with a URL that provides a connecting link to a source of information about the particular error as described above. The URL may be provided to a circuit 120b operable to generate data indicative of a machine-readable code identifying the URL associated with the particular error. The machine-readable code data may be provided to an LED matrix controller circuit 122b operable to send the machine-readable code data to a two-dimensional matrix of LEDs configured as a LED matrix display deice 130b. In one embodiment, a power storing circuit 142b may be a capacitance-based power storing circuit having one or more super or ultra capacitors configured to receive and store power from the serviceable system 100b during time normal operation thereof, i.e., at least during the time before an error is received by the serviceable system 100b. The power storing circuit 142b may be coupled to the LED matrix controller circuit 122b and the LED matrix display device 130b such that the LED controller circuit 122b only enables the display device 130b to be operable via the power storing circuit 140b when there is URL-indicating machine-readable code data ready to be displayed for indication of the particular error received by the serviceable system 100b. In this way, the code display device 130b is operable for illumination only when an error has been sensed or detected by the serviceable system 100b. Further, the code display device 130b is operable via power storing circuit 142b for illumination when an error has been received even if the serviceable system 100b is without power due to, for example, the particular error that was received.

FIG. 3C illustrates another embodiment of a serviceable system 100c configured with a coded service aid system in accordance with various aspects as described herein. In FIG. 3C, the serviceable system 100c implements various functional means, units, modules, or circuits (e.g., via the processing and control provided by BMC 106 and the processing blocks 110/120 in FIG. 2 and their software code or the like). In one embodiment, a baseboard management controller (BMC) 106c may be operable to receive error messages from a set of error sensing devices 104c (e.g., sensors 104 operable to sense or detect an error occurring in the respective sub-system 102 as in FIG. 2). In one embodiment, the BMC 106c includes, for instance, an error code generating circuit 107c that generates an error code each time the BMC 106c receives an indication of an error as sensed by one of the error sensing devices 104c. A look-up table 110c may be used to associate the generated error code with a URL that provides a connecting link to a source of information about the particular error as described above. The URL may be provided to a circuit 120c operable to generate data indicative of a machine-readable code identifying the URL associated with the particular error. The machine-readable code data may be provided to an LED matrix controller circuit 122c operable to send the machine-readable code data to a two-dimensional matrix of LEDs configured as a LED matrix display device 130c. In one embodiment, a power storing circuit 142c may be a capacitance-based power storing circuit configured to receive and store power from the serviceable system 100c during time normal operation thereof, i.e., at least during the time before an error is sensed at the serviceable system 100c. In one embodiment, a light device 150c (e.g., the failed-unit indicator light 150 in FIG. 2) may be provided at a position/location relative to the serviceable system 100c such that the light device 150c is readily visible to, for example, a technician even when the serviceable system 100c and the LED matrix display device 130c are not visible. The power storing circuit 142c may be coupled to the LED matrix controller circuit 122c, the LED matrix display device 130c, and the light device 150c such that the LED controller circuit 122c only enables the display device 130c and the light device 150c to be operable via the power storing circuit 142c when there is URL-indicating machine-readable code data ready to be displayed for indication of the particular error received by the serviceable system 100c. In this way, the code display device 130c and the light device 150c are operable for illumination only when an error has been received by the serviceable system 100c. Further, the code display device 130c and light device 150c are operable via the power storing circuit 142c for illumination when an error has been received even if the serviceable system 100c is without power due to, for example, the particular error that was received. Still further, when the light device 150c is enabled for operation, its illumination provides a clear indication of where the failed serviceable system 100c is located even when the serviceable system 100c is not visible.

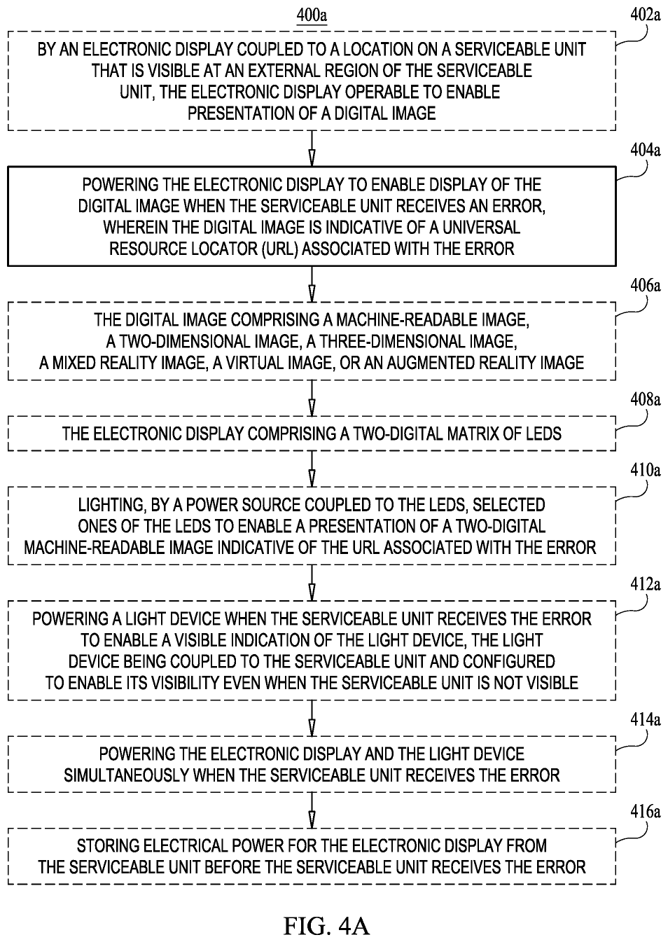

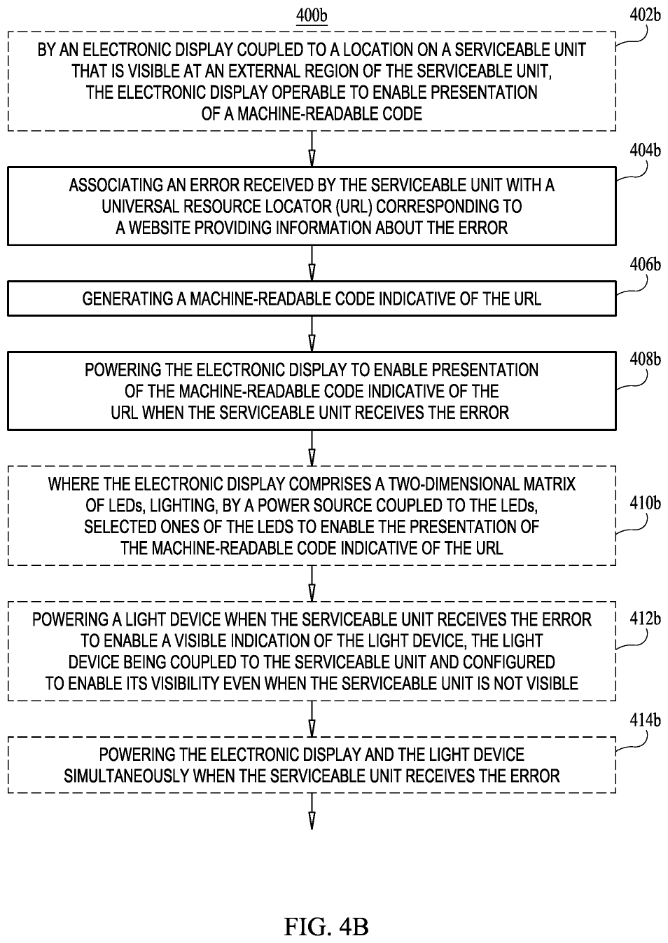

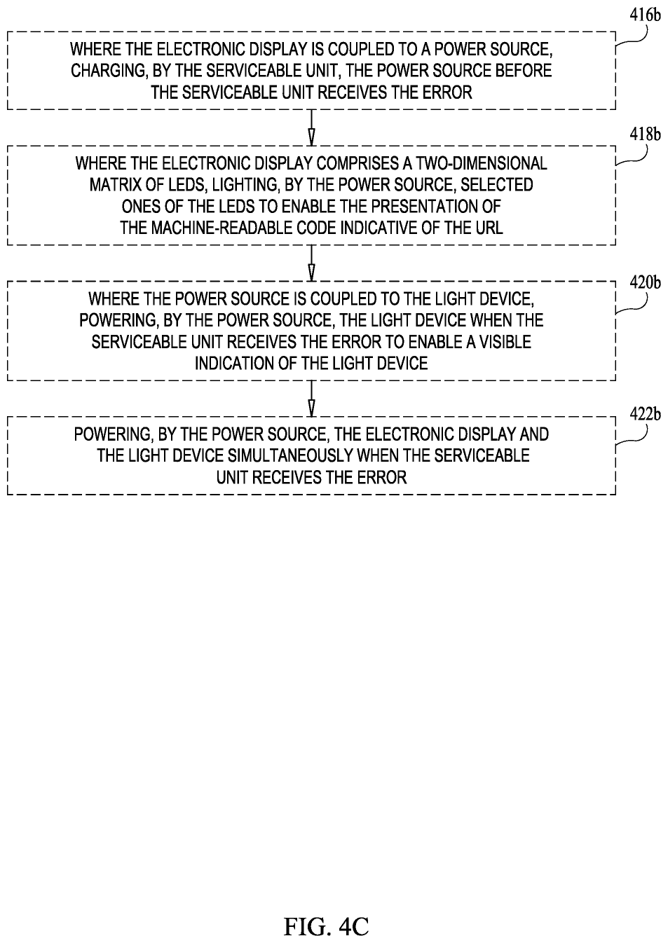

FIG. 4A illustrates one embodiment of a method 400a by an electronic display in accordance with various aspects as described herein. In FIG. 4A, the method 400a may start, for instance, at block 402a where the electronic display is coupled at a location on the serviceable unit that is visible at an external region thereof where the electronic display is operable to enable presentation of a digital image. At block 404a, the method 400a includes powering the electronic display to enable display of the digital image when the serviceable unit receives an error where the digital image is indicative of a Universal Resource Locator (URL) associated with the error. At block 406a, the method 400a may include the digital image comprising a machine-readable image, a two-dimensional image, a three-dimensional image, a mixed reality image, a virtual image, or an augmented reality image. At block 408a, the method 400a may include the electronic display comprising a two-dimensional matrix of LEDs. At block 410a, the method 400a may include lighting, by a power source coupled to the LEDs, selected ones of the LEDs to enable a presentation of a two-dimensional machine-readable image indicative of the URL associated with the error. At block 412a, the method 400a may further include powering a light device when the serviceable unit receives the error to enable a visible indication of the light device where the light device is coupled to the serviceable unit and configured to enable its visibility even when the serviceable unit is not visible. At block 414a, the method 400a may include powering the electronic display and the light device simultaneously when the serviceable unit receives the error. At block 416a, the method 400a may include storing electrical power for the electronic display from the serviceable unit before the serviceable unit receives the error.

FIGS. 4B-4C illustrate one embodiment of a method 400b by an electronic display in accordance with various aspects as described herein. In FIG. 4B, the method 400b may start, for instance, at block 402b where the electronic display is coupled at a location on the serviceable unit that is visible at an external region thereof where the electronic display is operable to enable presentation of a machine-readable code. At block 404b, the method 400b includes associating an error received by the serviceable unit with a Universal Resource Locator (URL) corresponding to a website providing information about the error. At block 406b, the method 400b includes generating a machine-readable code indicative of the URL. At block 408b, the method 400b includes powering the electronic display to enable presentation of the machine-readable code indicative of the URL when the serviceable unit receives the error. At block 410b, the method 400b may include, where the electronic display comprises a two-dimensional matrix of LEDs, lighting by a power source coupled to the LEDs selected ones of the LEDs to enable the presentation of the machine-readable code indicative of the URL. At block 412b, the method 400b may include powering a light device when the serviceable unit receives the error to enable a visible indication of the light device where the light device may be coupled to the serviceable unit and configured to enable its visibility even when the serviceable unit is not visible. At block 414b, the method 400b may include powering the electronic display and the light device simultaneously when the serviceable unit receives the error. Continuing to FIG. 4C at block 416b, the method 400b may include, where the electronic display is coupled to a power source, charging the power source by the serviceable unit before the serviceable unit receives the error. At block 418b, the method 400b may include, where the electronic display comprises a two-dimensional matrix of LEDs, lighting selected ones of the LEDs by the charged power source to enable the presentation of the machine-readable code indicative of the URL. At block 420b, the method 400b may include, where the power source is coupled to the light device, powering the light device by the power source when the serviceable unit receives the error to enable a visible indication of the light device. At block 422b, the method 400b may include powering, by the power source, the electronic display and the light device simultaneously when the serviceable unit receives the error.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts for illustrative purposes, but the embodiments are similarly applicable in other contexts not explicitly described.

In one exemplary embodiment, a method is performed by an electronic display coupled to location on a serviceable unit that is visible at an external region of the serviceable unit. The electronic display is operable to enable presentation of a digital image. The method includes powering the electronic display to enable display of the digital image when the serviceable unit receives an error. The digital image is indicative of a Universal Resource Locator (URL) associated with the error.

In another exemplary embodiment, the method is performed for a digital image comprising a machine-readable image, a two-dimensional image, a three-dimensional image, a mixed reality image, a virtual image, or an augmented reality image.

In another exemplary embodiment, the electronic display comprises a two-dimensional matrix of LEDs, and the method further includes lighting, by a power source coupled to the LEDs, selected ones of the LEDs to enable a presentation of a two-dimensional machine-readable image indicative of the URL associated with the error.

In another exemplary embodiment, the method further includes powering a light device when the serviceable unit receives the error to enable a visible indication of the light device where the light device is coupled to the serviceable unit and configured to enable its visibility even when the serviceable unit is not visible.

In another exemplary embodiment, the method further includes powering the electronic display and the light device simultaneously when the serviceable unit receives the error.

In another exemplary embodiment, the method further includes storing electrical power for the electronic display from the serviceable unit before the serviceable unit receives the error.

In one exemplary embodiment, a device includes an electronic display adapted to be coupled to a location on a serviceable unit that is visible at an external region of the serviceable unit. The electronic display is operable to enable presentation of a digital image when the serviceable unit receives an error. The digital image is indicative of a Universal Resource Locator (URL) associated with the error. The device includes a power source coupled to the electronic display and operable to provide power to the electronic display to display the digital image when the serviceable unit receives the error.

In another exemplary embodiment, the device's digital image comprises a machine-readable image, a two-dimensional image, a three-dimensional image, a mixed reality image, a virtual image, or an augmented reality image.

In another exemplary embodiment, the device's electronic display comprises a two-dimensional matrix of LEDs.

In another exemplary embodiment, the device's power source comprises at least one capacitor operable to enable storage of electrical power received from the serviceable unit before the error is received.

In another exemplary embodiment, the device further includes a light device adapted to be coupled to the serviceable unit and configured to enable its visibility even when the serviceable unit is not visible. The light device is operable to enable a visible indication thereof when the serviceable unit receives the error. The light device is further coupled to the power source where the visible indication is enabled when the serviceable unit receives the error.

In another exemplary embodiment, the device's electronic display and light device are configured to be enabled simultaneously by the power source when the serviceable unit receives the error.

In one exemplary embodiment, a method is performed by an electronic display coupled to a location on a serviceable unit that is visible at an external region of the serviceable unit. The electronic display is operable to enable presentation of a machine-readable code. The method includes associating an error received by the serviceable unit with a Universal Resource Locator (URL) corresponding to a website providing information about the error, generating a machine-readable code indicative of the URL, and powering the electronic display to enable presentation of the machine-readable code indicative of the URL when the serviceable unit receives the error.

In another exemplary embodiment, where the electronic display comprises a two-dimensional matrix of LEDs, the method further includes lighting, by a power source coupled to the LEDs, selected ones of the LEDs to enable the presentation of the machine-readable code indicative of the URL.

In another exemplary embodiment, the method further includes powering a light device when the serviceable unit receives the error to enable a visible indication of the light device where the light device is coupled to the serviceable unit and configured to enable its visibility even when the serviceable unit is not visible.

In another exemplary embodiment, the method further includes powering the electronic display and the light device simultaneously when the serviceable unit receives the error.

In another exemplary embodiment, where the electronic display is coupled to a power source, the method further includes charging, by the serviceable unit, the power source before the serviceable unit receives the error.

In another exemplary embodiment, where the electronic display comprises a two-dimensional matrix of LEDs, the method further includes lighting, by the power source, selected ones of the LEDs to enable the presentation of the machine-readable code indicative of the URL.

In another exemplary embodiment, where the power source is coupled to the light device, the method further includes powering, by the power source, the light device when the serviceable unit receives the error to enable a visible indication of the light device.

In another exemplary embodiment, the method further includes powering, by the power source, the electronic display and the light device simultaneously when the serviceable unit receives the error.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein. Alternatively, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method, comprising:
by an electronic display coupled to a location on a serviceable unit that is visible at an external region of the serviceable unit, the electronic display operable to enable presentation of a digital image,
powering the electronic display to enable display of the digital image when the serviceable unit receives an error, wherein the digital image is indicative of a Universal Resource Locator (URL) associated with the error.

2. The method of claim 1, wherein the digital image comprises a machine-readable image, a two-dimensional image, a three-dimensional image, a mixed reality image, a virtual image, or an augmented reality image.

3. The method of claim 1, wherein the electronic display comprises a two-dimensional matrix of LEDs, the method further comprising:
lighting, by a power source coupled to the LEDs, selected ones of the LEDs to enable a presentation of a two-dimensional machine-readable image indicative of the URL associated with the error.

4. The method of claim 1, further comprising:
powering a light device when the serviceable unit receives the error to enable a visible indication of the light device, the light device being coupled to the serviceable unit and configured to enable its visibility even when the serviceable unit is not visible.

5. The method of claim 4, further comprising:
powering the electronic display and the light device simultaneously when the serviceable unit receives the error.

6. The method of claim 1, further comprising:
storing electrical power for the electronic display from the serviceable unit before the serviceable unit receives the error.

7. A device, comprising:
an electronic display adapted to be coupled to a location on a serviceable unit that is visible at an external region of the serviceable unit, the electronic display operable to enable presentation of a digital image when the serviceable unit receives an error, the two-dimensional image being indicative of a Universal Resource Locator (URL) associated with the error; and
a power source coupled to the electronic display and operable to provide power to the electronic display to display the digital image when the serviceable unit receives the error.

8. The device of claim 7, wherein the digital image comprises a machine-readable image, a two-dimensional image, a three-dimensional image, a mixed reality image, a virtual image, or an augmented reality image.

9. The device of claim 7, wherein the electronic display comprises a two-dimensional matrix of LEDs.

10. The device of claim 7, wherein the power source comprises at least one capacitor operable to enable storage of electrical power received from the serviceable unit before the error is received.

11. The device of claim 7, further comprising:
a light device adapted to be coupled to the serviceable unit and configured to enable its visibility even when the serviceable unit is not visible, the light device operable to enable a visible indication of the light device when the serviceable unit receives the error, the light device further coupled to the power source wherein the visible indication is enabled when the serviceable unit receives the error.

12. The device of claim 11, wherein the electronic display and the light device are configured to be enabled simultaneously by the power source when the serviceable unit receives the error.

13. A method, comprising:
by an electronic display coupled to a location on a serviceable unit that is visible at an external region of the serviceable unit, the electronic display operable to enable presentation of a machine-readable code,
associating an error received by the serviceable unit with a Universal Resource Locator (URL) corresponding to a website providing information about the error;
generating a machine-readable code indicative of the URL; and
powering the electronic display to enable presentation of the machine-readable code indicative of the URL when the serviceable unit receives the error.

14. The method of claim 13, wherein the electronic display comprises a two-dimensional matrix of LEDs, the method further comprising:
lighting, by a power source coupled to the LEDs, selected ones of the LEDs to enable the presentation of the machine-readable code indicative of the URL.

15. The method of claim 13, further comprising:
powering a light device when the serviceable unit receives the error to enable a visible indication of the light device, the light device being coupled to the serviceable unit and configured to enable its visibility even when the serviceable unit is not visible.

16. The method of claim 15, further comprising:
powering the electronic display and the light device simultaneously when the serviceable unit receives the error.

17. The method of claim 15, wherein the electronic display is coupled to a power source, the method further comprising:
charging, by the serviceable unit, the power source before the serviceable unit receives the error.

18. The method of claim 17, wherein the electronic display comprises a two-dimensional matrix of LEDs, the method further comprising:
lighting, by the power source, selected ones of the LEDs to enable the presentation of the machine-readable code indicative of the URL.

19. The method of claim 17, wherein the power source is coupled to the light device, the method further comprising:
powering, by the power source, the light device when the serviceable unit receives the error to enable a visible indication of the light device.

20. The method of claim 19, further comprising:
powering, by the power source, the electronic display and the light device simultaneously when the serviceable unit receives the error.
